(19) United States
(12) Patent Application Publication
(10) Pub. No.: US 2018/0363767 A1
(43) Pub. Date: Dec. 20, 2018

(54) TRANSMISSION CONTROL DEVICE DETECTING STATE OF SHIFT LEVEL AND VEHICLE USING THE SAME

(71) Applicant: KYUNG CHANG INDUSTRIAL CO., Ltd., Daegu (KR)

(72) Inventor: Dong Won KIM, Daegu (KR)

(21) Appl. No.: 16/010,624

(22) Filed: Jun. 18, 2018

(30) Foreign Application Priority Data
Jun. 20, 2017 (KR) 10-2017-0078115

(51) Int. Cl. F16H 59/04; F16H 63/50; G01D 5/14

(52) U.S. Cl. CPC F16H 59/044; F16H 2059/0269; G01D 5/145; F16H 63/50

(57) ABSTRACT

A transmission control device may be provided that includes: a gear lever which is movable in a select direction and in a shift direction; a shift lever which is connected to the gear lever; a guide lever one end of which is fixed to the shift lever and the other end of which has a magnet; a sensor which is disposed adjacent to the magnet and detects a position of the magnet that moves in association with the gear lever; and a controller which determines a state of the gear lever on the basis of the position of the magnet detected by the sensor. Therefore, it is possible to detect the change of the shift level with a simple structure and to accurately recognize whether the shift level is in the neutral state or not, thereby driving the Idle Stop & Go (ISG) function.

### BACKGROUND

### Field

The present disclosure relates to a transmission control device detecting the state of a shift level and a vehicle using the same, and more particularly to a transmission control device which determines whether the shift level is at a neutral position or not and drives Idle Stop & Go (ISG) function and a vehicle using the same.

### Description of the Related Art

A transmission converts the power generated by an engine into a rotational force. In an internal combustion engine, a Revolution Per Minute (RPM) band for obtaining the maximum torque is different from a Revolution Per Minute (RPM) band for obtaining the maximum output. Therefore, it is necessary to select an appropriate shift position in accordance with the speed of a vehicle or an engine RPM and to convert the power into the rotational force.

Here, a transmission control device controls the transmission. The transmission control device is divided into a manual shift control device (a manual transmission) and an automatic shift control device (an automatic transmission). The manual shift control device changes manually the shift position by user's operations. The automatic shift control device changes automatically the shift position.

Meanwhile, a state in which the engine of the vehicle is started but the vehicle is not traveling is referred to as an idling state. Since the engine is undoubtedly working even in the idling state, fuel is consumed, so that not only fuel efficiency is degraded, but also air pollution is caused. Therefore, for the purpose of solving such problems, research is being devoted to the Idle Stop & Go (ISG) function that detects the idling state and turns off the engine. Further, a vehicle equipped with this function is being manufactured.

In the case of the manual shift control device, in an existing device that implements the (ISG) function, a sensor which detects the state where the vehicle is not traveling has a large and complex structure and is thus difficult to install in a narrow space.

For example, a prior art document, Korean Laid-open Patent Application No. 10-2014-0075175 (Jun. 19, 2014) describes the (ISG) function, but does not disclose in detail the sensor which detects the state where the vehicle is not traveling. Therefore, the prior art document still does not propose a transmission control device which can be installed in a narrow space.

### SUMMARY

An object of the present invention is to provide a transmission control device which detects the change of a shift level with a simple structure. Particularly, the object of the present invention is to provide a transmission control device capable of accurately recognizing whether the shift level is in the neutral state or not.

One embodiment is a transmission control device including: a gear lever which is movable in a select direction and in a shift direction; a shift lever which is connected to the gear lever; a guide lever one end of which is fixed to the shift lever and the other end of which has a magnet; a sensor which is disposed adjacent to the magnet and detects a position of the magnet that moves in association with the gear lever; and a controller which determines a state of the gear lever on the basis of the position of the magnet detected by the sensor.

The shift lever may be configured to be substantially orthogonal to the gear lever, and the guide lever may be configured to be substantially orthogonal to the shift lever. Here, the guide lever may be configured to be orthogonal to the shift lever and to be orthogonal to the gear lever. Specifically, the shift lever may extend in the select direction from a rotation center of the gear lever, and the guide lever may extend in the shift direction from an extended end of the shift lever.

The sensor may be disposed to detect the position of the magnet when the gear lever is at the neutral position.

On the basis of a signal sensed by the sensor, the controller can determine whether the gear lever is at the neutral position or not.

The position of the magnet may be moved in association with the gear lever in accordance with a change of a shift level, and the sensor may be provided for each position of the magnet corresponding to the shift level.

The controller can determine the state of the gear lever on the basis of a signal sensed by each of the sensors.

The sensor may be a Hall Integrated Circuit (IC).

Another embodiment is a vehicle including: an engine which generates power; a transmission which uses different gears according to a shift level and converts the power into a rotatory power; and a transmission control device which controls the shift level. The transmission control device includes: a gear lever which is movable in a select direction and in a shift direction; a shift lever which is connected to the gear lever; a guide lever one end of which is fixed to the shift lever and the other end of which has a magnet; a sensor which is disposed adjacent to the magnet and detects a position of the magnet that moves in association with the gear lever; and a controller which determines a state of the gear lever on the basis of the position of the magnet detected by the sensor.

The shift lever may be configured to be substantially orthogonal to the gear lever, and the guide lever may be configured to be substantially orthogonal to the shift lever.

The shift lever may extend in the select direction from a rotation center of the gear lever, and the guide lever may extend in the shift direction from an extended end of the shift lever.

The vehicle may further include an electronic control unit (ECU) which drives Idle Stop & Go (ISG) function on the basis of the measured magnet field at a neutral level where the power of the engine is not transmitted to wheels.

The sensor may be disposed to detect the position of the magnet when the gear lever is at a neutral position, and, on the basis of a signal sensed by the sensor, the controller can determine whether the gear lever is at the neutral position or not.

According to the transmission control device and the vehicle according to the embodiments of the present invention, it is possible to detect the change of the shift level with a simple structure and to accurately recognize whether the shift level is in the neutral state or not, thereby driving the Idle Stop & Go (ISG) function.

### BRIEF DESCRIPTION OF THE DRAWINGS

FIG. 1 is a perspective view of a transmission control device of a manual transmission according to an embodiment of the present invention;

FIG. 2 is a view showing a shift pattern marked on a knob surrounding a shift lever in the transmission control device of the manual transmission according to the embodiment of the present invention;

FIG. 3a, FIG. 3b, FIG. 4a, FIG. 4b, FIG. 5a and FIG. 5b are views for describing the configuration and operation of the transmission control device according to the embodiment of the present invention;

FIG. 6 shows the configuration of a transmission control device according to another embodiment of the present invention; and

FIG. 7 is a block diagram showing the configuration of a vehicle according to the embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. Similar reference numerals in the drawings designate the same or similar functions in many aspects.

Also, in the components of the present invention, detailed descriptions of what can be clearly understood and easily carried into practice by those skilled in the art will be omitted to avoid making the subject matter of the present invention unclear.

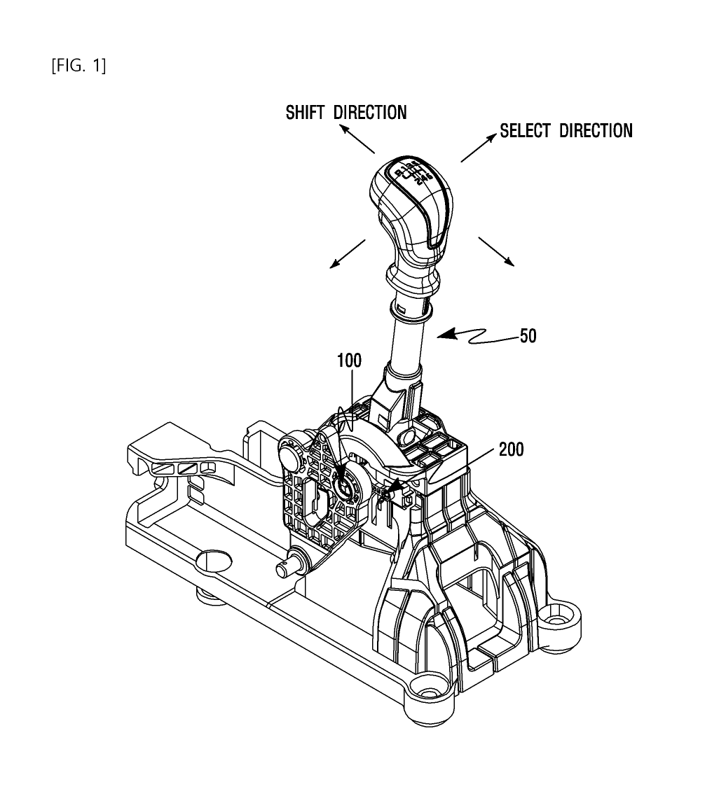

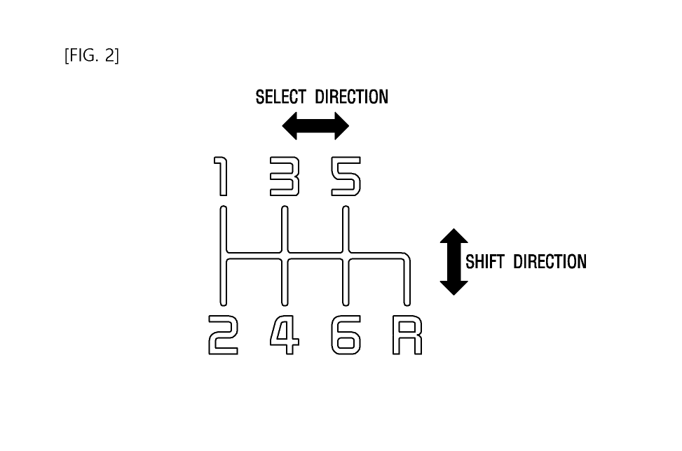

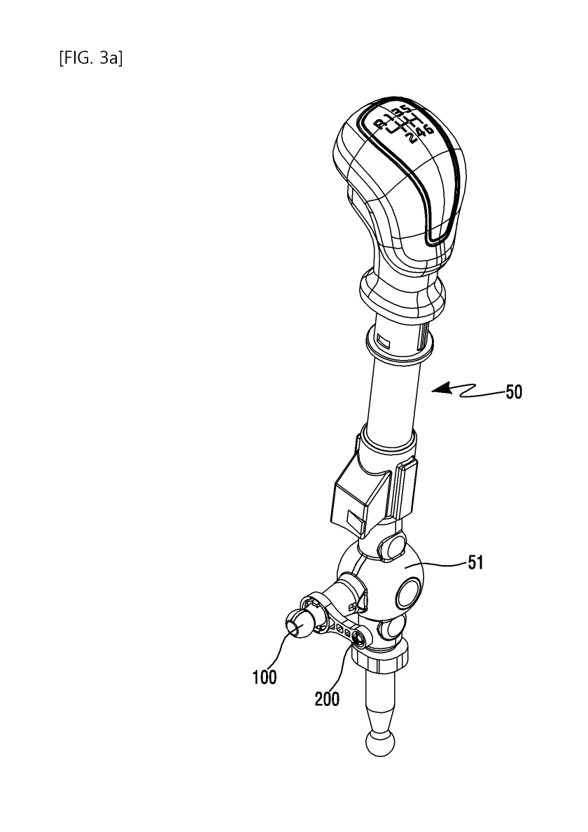

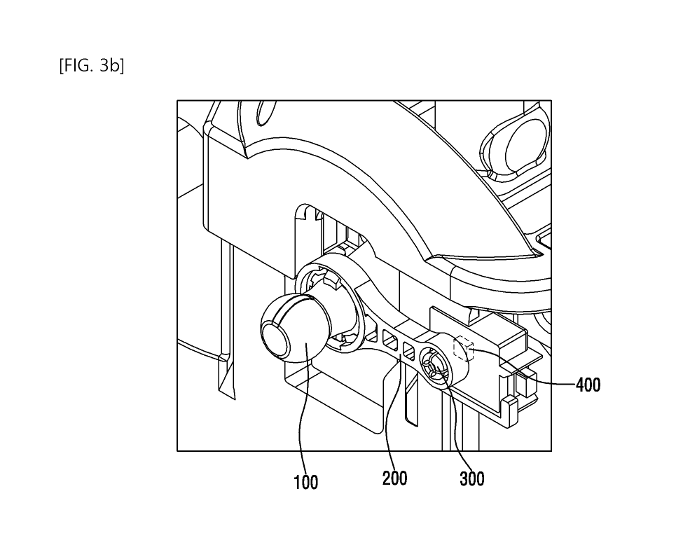

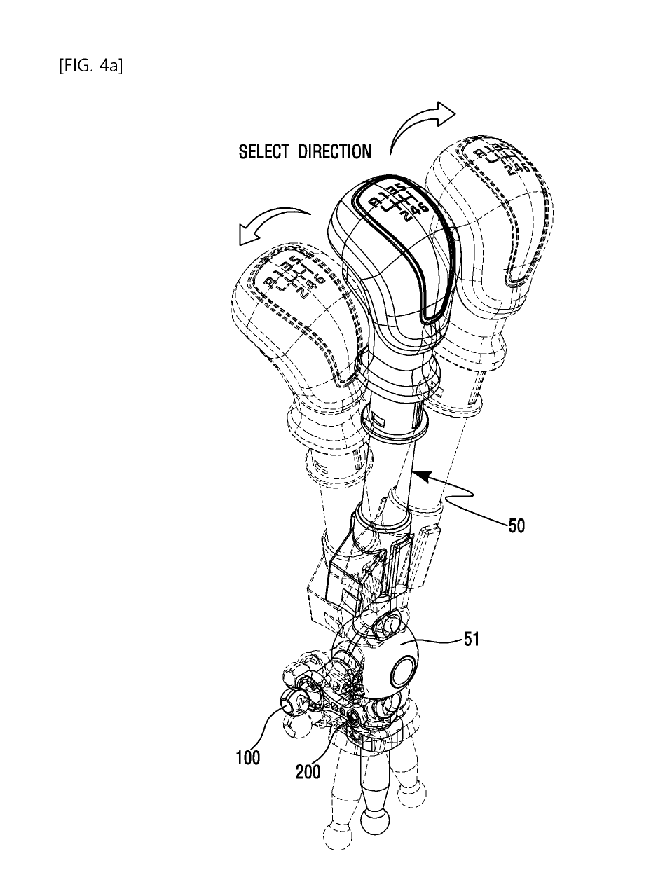

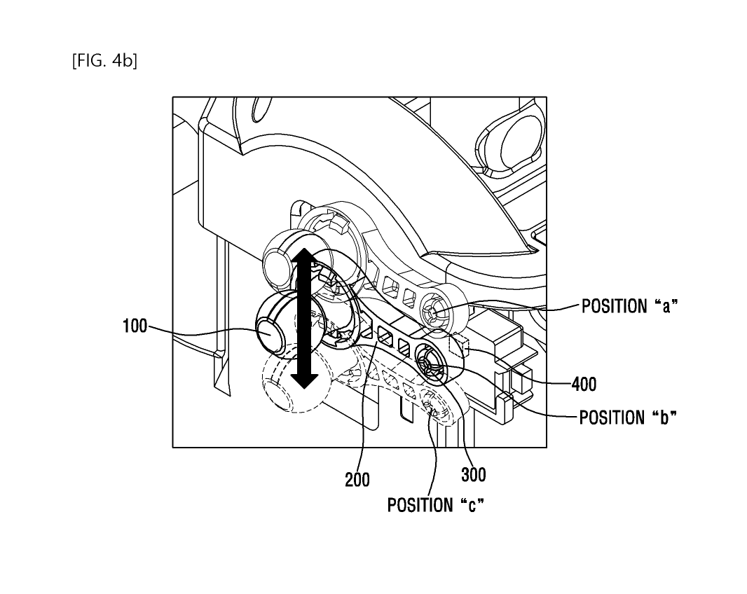

FIGS. 1 and 2 are views for describing a basic operation of a transmission control device according to an embodiment of the present invention. FIG. 1 is a perspective view of the transmission control device of a manual transmission according to the embodiment of the present invention. FIG. 2 is a view showing a shift pattern marked on a knob surrounding a shift lever in the transmission control device of the manual transmission according to the embodiment of the present invention. FIGS. 3a to 5b are views for describing the configuration and operation of the transmission control device according to the embodiment of the present invention.

As shown in FIGS. 1 to 5b, the transmission control device according to the embodiment of the present invention basically includes a gear lever 50, a shift lever 100, and a guide lever 200.

The gear lever 50 is moved in a select direction or in a shift direction by the operation of a driver. The shift pattern shown in FIG. 2 may be formed in a knob of the gear lever 50. The driver controls a clutch (not shown) and the gear lever 50 in accordance with the speed of a vehicle, and changes the gear shift stage in accordance with the shift pattern.

Here, the following description will be provided by assuming that the gear shift stages that can be controlled by the transmission control device of a manual transmission according to the embodiment of the present invention are a total of six forward gear shifts of the first to sixth gear shift stages and a reverse gear shift of R gear shift stage. Also, it is apparent to those skilled in the art that the number of gear shift stages is not limited to this and a larger or smaller number of gear shift stages can be provided.

Generally, the transmission is installed between the clutch and final reduction gears/differential gears. The transmission changes the rotational torque and rotational speed of an engine and transfers to the final reduction gears/differential gears.

In the transmission grading, a maximum shift ratio and a minimum shift ratio are determined by considering the maximum speed and climbing angle of the vehicle, and then the shift ratios of the medium gears are determined. Here, the shift ratio refers to each ratio of the gears at a point of time when the output of the engine, which has been generated by a crank shaft, is converted into a driving force within the transmission.

The driver controls the gear lever 50 and the clutch depending on the speed of a vehicle and changes the gear shift stage into a gear shift stage suitable for the speed. Each of the gear shift stages has its appropriate speed range.

For example, the first gear shift stage and the second gear shift stage are applied when the speed of the vehicle is approximately less than 40 km/h. The third gear shift stage and the fourth gear shift stage are applied the speed of the vehicle is approximately 40 km/h to 80 km/h. The fifth gear shift stage and the sixth gear shift stage are applied the speed of the vehicle is approximately greater than 80 km/h. Furthermore, according to the specification of the vehicle, the appropriate speed corresponding to each of the gear shift stages may be set to be different from that described above.

The driver should move the gear lever 50 in up, down, right and left directions shown in the pattern of FIG. 2 so as to change the gear shift stage. Here, the right and left direction of the pattern of FIG. 2 is referred to as the select direction, and the up and down direction is referred to as the shift direction.

When the speed of the vehicle traveling at the second gear shift stage increases and reaches a speed corresponding to the third gear shift stage, the driver steps on the clutch pedal and moves the gear lever 50 to the position 3 in the pattern.

Furthermore, when the speed increases and reaches a speed corresponding to the fourth gear shift stage, the driver steps on the clutch pedal and moves the gear lever 50 to the position 4 in the pattern.

As such, the driver cannot change the gear shift stage from the first gear shift stage to the sixth gear shift stage or to R gear shift stage by moving the gear lever 50 in the select direction or in the shift direction.

FIGS. 3a to 5b are views for describing the configuration and operation of the transmission control device according to the embodiment of the present invention. As shown in FIGS. 3a and 3b, the shift lever 100 is connected to the gear lever 50, and the guide lever 200 is connected to the shift lever 100. That is, one end of the guide lever 200 is fixed to the shift lever 100.

More specifically, as shown in FIGS. 3a and 3b, the shift lever 100 protrudes from a rotation center 51 of the gear lever 50 in the select direction. One end of the guide lever 200 is fixed to the protruding end of the shift lever 100, and the other end of the guide lever 200 is arranged to extend in the shift direction from the end fixed to the lever 100.

The gear lever 50 and the shift lever 100 may be configured to be substantially orthogonal to each other, and the shift lever 100 and the guide lever 200 may also be configured to be substantially orthogonal to each other. The shift lever 100 extends in the select direction from the rotation center 51 where the gear lever 50 and the shift lever 100 intersect, and the guide lever 200 extends in the shift direction from the extended end of the shift lever 100. As a result, the operating space of the shift lever 100 and the guide lever 200 can be minimized, and the range of movement of a magnet 300 disposed at the other end of the guide lever 200 can be minimized as well.

Meanwhile, the magnet 300 is disposed at the other end of the guide lever 200. Therefore, when a user moves the gear lever 50 for shifting, the shift lever 100 and the guide lever 200 move, and in association with this, the position of the magnet 300 is changed.

FIGS. 4a and 4b show the movement of the magnet 300 when the user moves the gear lever 50 in the select direction. When the gear lever 50 moves in the select direction, one end of the shift lever 100 connected to the gear lever 50, and the guide lever 200 connected to the end of the shift lever 100 move up and down. Accordingly, the magnet 300 moves between the position “a” and the position “c”.

More specifically, when the user moves the gear lever 50 in the select direction, the gear lever 50 rotates about the rotation center 51 in the select direction, and thus, the protruding end of the shift lever 100 moves up and down. When the protruding end of the shift lever 100 moves up and down, the guide lever 200 fixed to the protruding end of the shift lever 100 moves up and down as well. Accordingly, the magnet 300 moves between the position “a” and the position “c”.

Meanwhile, a sensor 400 is on the same line with the magnet 300 at a regular interval. Therefore, when the magnet 300 moves, the sensor 400 detects a distance change of the magnet 300 through the strength of the magnetic field, and particularly, can accurately detect that the magnet 300 is at the neutral position (position b).

FIGS. 5a and 5b show the movement of the magnet 300 when the user moves the gear lever 50 in the shift direction. When the gear lever 50 moves in the shift direction, one end of the shift lever 100 connected to the gear lever 50, and the guide lever 200 connected to the end of the shift lever 100 rotate. Accordingly, the magnet 300 moves between the position “d” and the position “f”.

More specifically, when the user moves the gear lever 50 in the shift direction, the gear lever 50 rotates about the rotation center 51 in the shift direction, and thus, the shift lever 100 rotates. When the shift lever 100 rotates, the guide lever 20 rotates in the shift direction about the end of the guide lever 200 fixed to the protruding end of the shift lever 100. Accordingly, the magnet 300 moves between the position “d” and the position “f”.

Meanwhile, the sensor 400 is on the same line with the magnet 300 at a regular interval. Therefore, when the magnet 300 moves, the sensor 400 detects the distance change of the magnet 300 through the strength of the magnetic field, and particularly, can accurately detect that the magnet 300 is at the neutral position (position e).

In the above description, the sensor 400 can be implemented by a Hall integrated circuit (IC). The hall IC is a magnetic sensor which measures the direction or intensity of the magnetic field by using a hall effect. The sensor 400 is on the same line with the magnet 300 at a regular interval and detects the distance change of the magnet 300 through the strength of the magnetic field.

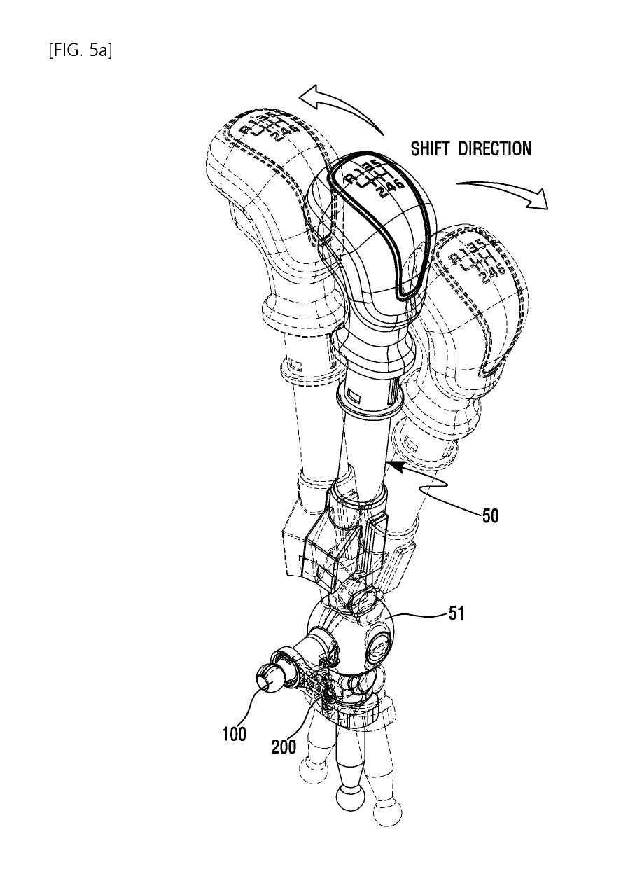

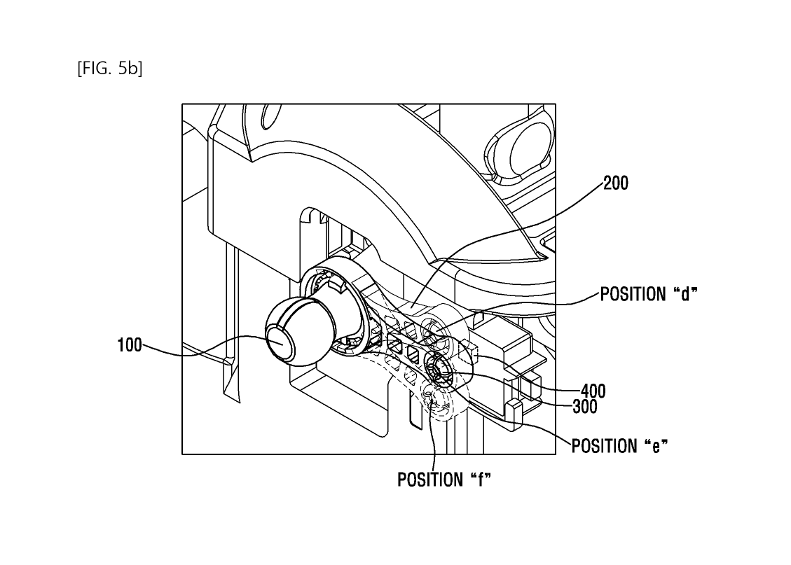

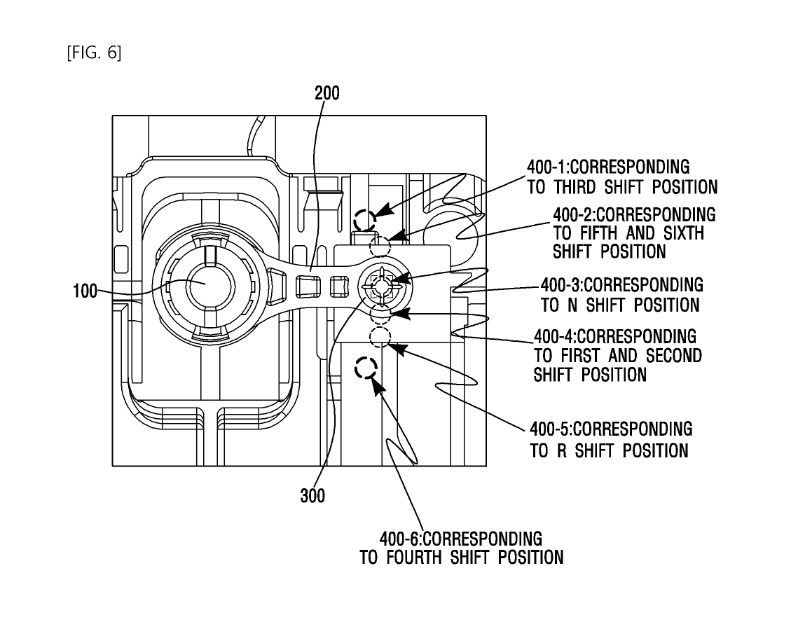

FIG. 6 shows the configuration of a transmission control device according to another embodiment of the present invention. In the embodiment of FIG. 6, a plurality of sensors 400-1 to 400-6 are provided. When the shift lever 100 moves for shifting in the select direction and/or in the shift direction, the magnet 300 has, as shown in FIG. 6, positions corresponding to the gear shift stages respectively.

Here, the sensors 400-1 to 400-6 are installed at the positions corresponding to the gear shift stages respectively, so that the current state of the gear shift stage can be recognized by a signal sensed by each of the sensors 400-1 to 400-6.

For example, the first sensor 400-1 is provided on the same line at a regular interval at the position of the magnet 300 corresponding to the third shift position. The second sensor 400-2 is provided on the same line at a regular interval at the position of the magnet 300 corresponding to the fifth and sixth shift position. The third sensor 400-3 is provided on the same line at a regular interval at the position of the magnet 300 corresponding to the N shift position (neutral shift position). The fourth sensor 400-4 is provided on the same line at a regular interval at the position of the magnet 300 corresponding to the first and second shift positions. The fifth sensor 400-5 is provided on the same line at a regular interval at the position of the magnet 300 corresponding to the R shift position. The sixth sensor 400-6 is provided on the same line at a regular interval at the position of the magnet 300 corresponding to the fourth shift position.

By using the strength of the magnet field sensed by each of the sensors 400-1 to 400-6, the current state of the gear shift stage can be recognized, and the signal can be used in the overall control of the vehicle.

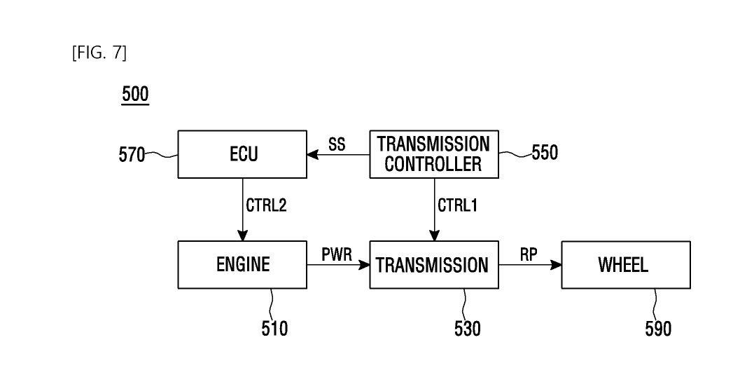

FIG. 7 is a block diagram showing the configuration of the vehicle according to the embodiment of the present invention. As shown in FIG. 7, the vehicle 500 may include the engine 510, the transmission 530, and the transmission control device 550. According to the embodiment, the vehicle 500 may further include an electronic control unit 570 and/or wheels 590.

The engine 510 can generate power (PWR). The generated power (PWR) is transmitted to the transmission 530. The transmission 530 can convert the power (PWR) into rotatory power (RP). For this, the transmission 530 can use different gears according to the shift level. The generated rotatory power (RP) can be transmitted to the wheels 590.

The transmission control device 550 can control the transmission 530 by controlling the shift level. For example, the transmission control device 550 can control the transmission 530 mechanically and/or electrically.

The transmission control device 550 includes the gear lever 50, the shift lever 100, the guide lever 200, the magnet 300, and the sensor 400. The shift lever 100 is connected to the gear lever 50, and the guide lever 200 is connected to the shift lever 100. That is, one end of the guide lever 200 is fixed to the shift lever 100.

Meanwhile, the magnet 300 is disposed at the other end of the guide lever 200.

Therefore, when a user moves the gear lever 50 for shifting, the shift lever 100 and the guide lever 200 move, and in association with this, the position of the magnet 300 is changed.

When the gear lever 50 moves in the select direction, one end of the shift lever 100 connected to the gear lever 50, and the guide lever 200 connected to the end of the shift lever 100 move up and down. Accordingly, the magnet 300 moves between the position “a” and the position “c” of FIG. 4b.

Meanwhile, the sensor 400 is on the same line with the magnet 300 at a regular interval. Therefore, when the magnet 300 moves, the sensor 400 detects a distance change of the magnet 300 through the strength of the magnetic field, and particularly, can accurately detect that the magnet 300 is at the neutral position (position b).

When the gear lever 50 moves in the shift direction, one end of the shift lever 100 connected to the gear lever 50, and the guide lever 200 connected to the end of the shift lever 100 rotate. Accordingly, the magnet 300 moves between the position “d” and the position “f” of FIG. 5b.

Meanwhile, the sensor 400 is on the same line with the magnet 300 at a regular interval. Therefore, when the magnet 300 moves, the sensor 400 detects the distance change of the magnet 300 through the strength of the magnetic field, and particularly, can accurately detect that the magnet 300 is at the neutral position (position e).

The sensor 400 can be implemented by a Hall integrated circuit (IC). The hall IC is a magnetic sensor which measures the direction or intensity of the magnetic field by using a hall effect. The sensor 400 is on the same line with the magnet 300 at a regular interval and detects the distance change of the magnet 300 through the strength of the magnetic field.

Meanwhile, the plurality of sensors 400-1 to 400-6 may be provided in the transmission control device. When the shift lever 100 moves for shifting in the select direction and/or in the shift direction, the magnet 300 has, as shown in FIG. 6, positions corresponding to the gear shift stages respectively.

Here, the sensors 400-1 to 400-6 are installed at the positions corresponding to the gear shift stages respectively, so that the current state of the gear shift stage can be recognized by a signal sensed by each of the sensors 400-1 to 400-6.

For example, the first sensor 400-1 is provided on the same line at a regular interval at the position of the magnet 300 corresponding to the third shift position. The second sensor 400-2 is provided on the same line at a regular interval at the position of the magnet 300 corresponding to the fifth and sixth shift position. The third sensor 400-3 is provided on the same line at a regular interval at the position of the magnet 300 corresponding to the N shift position (neutral shift position). The fourth sensor 400-4 is provided on the same line at a regular interval at the position of the magnet 300 corresponding to the first and second shift positions. The fifth sensor 400-5 is provided on the same line at a regular interval at the position of the magnet 300 corresponding to the R shift position. The sixth sensor 400-6 is provided on the same line at a regular interval at the position of the magnet 300 corresponding to the fourth shift position.

By using the strength of the magnet field sensed by each of the sensors 400-1 to 400-6, the current state of the gear shift stage can be recognized, and the signal can be used in the overall control of the vehicle.

The electronic control unit 570 receives information from various sensors and is configured to operate various circuits and systems. In order that the engine is operated with the optimal performance in response to all the operation states of the vehicle, the electronic control unit 570 receives input signals from the various sensors and calculates an optimal amount of fuel injection, fuel injection timing, ignition timing, air amount, etc., which are based on each of the driving conditions and have an important influence on the drivability of the vehicle, exhaust gas, fuel efficiency, etc. Through this, the controller 500 functions to control the engine through an actuator such as an injector, ignition coil, etc. The electronic control unit 600 can sense the speed of the vehicle through various sensors.

Particularly, the electronic control unit 570 of the embodiment of the present invention drives Idle Stop & Go (ISG) function on the basis of the measured magnet field. For this, the electronic control unit 570 can control the starting of the engine 510 mechanically and/or electrically. For example, the electronic control unit 570 can drive the Idle Stop & Go (ISG) function on the basis of the magnet field measured at the neutral level where the power (PWR) of the engine 510 is not finally transmitted to the wheels 590. That is, the electronic control device 570 can turn off the engine 510 at the neutral level. It is also possible to check whether the shift level is the neutral level or not by means of the aforementioned transmission control device 550.

The wheel 590 moves the vehicle 500 forward or backward by a friction force with the ground in accordance with the rotatory power RP.

The vehicle 500 according to the embodiments of the present invention includes the transmission control device 550. As a result, it is possible to detect the neutral level, i.e., an intermediate state during the change of the shift level and to implement the Idle Stop & Go (ISG) function. Furthermore, not only the neutral level but also respective gear shift stages can be detected. The detected signal can be variously used in the overall control of the vehicle 500.

While the transmission control device according to the embodiments of the present invention and a vehicle including the same have been described, the foregoing embodiments are merely exemplary and may be changed or modified without departing from the technical spirit of the present invention by a person having ordinary skill in the art to which the present invention pertains to.

What is claimed is:

1. A transmission control device comprising:
a gear lever which is movable in a select direction and in a shift direction;
a shift lever which is connected to the gear lever;
a guide lever one end of which is fixed to the shift lever and the other end of which has a magnet;
a sensor which is disposed adjacent to the magnet and detects a position of the magnet that moves in association with the gear lever; and
a controller which determines a state of the gear lever on the basis of the position of the magnet detected by the sensor.

2. The transmission control device of claim 1,
wherein the shift lever is configured to be substantially orthogonal to the gear lever,
and wherein the guide lever is configured to be substantially orthogonal to the shift lever.

3. The transmission control device of claim 2,
wherein the shift lever extends in the select direction from a rotation center of the gear lever,
and wherein the guide lever extends in the shift direction from an extended end of the shift lever.

4. The transmission control device of claim 1, wherein the sensor is disposed to detect the position of the magnet when the gear lever is at the neutral position.

5. The transmission control device of claim 4, wherein, on the basis of a signal sensed by the sensor, the controller determines whether the gear lever is at the neutral position or not.

6. The transmission control device of claim 1, wherein the position of the magnet is moved in association with the gear lever in accordance with a change of a shift level, and wherein the sensor is provided for each position of the magnet corresponding to the shift level.

7. The transmission control device of claim 6, wherein the controller determines the state of the gear lever on the basis of a signal sensed by each of the sensors.

8. The transmission control device of claim 1, wherein the sensor is a Hall Integrated Circuit (IC).

9. A vehicle comprising:
an engine which generates power;
a transmission which uses different gears according to a shift level and converts the power into a rotatory power; and
a transmission control device which controls the shift level,
wherein the transmission control device comprises:
a gear lever which is movable in a select direction and in a shift direction;
a shift lever which is connected to the gear lever;
a guide lever one end of which is fixed to the shift lever and the other end of which has a magnet;
a sensor which is disposed adjacent to the magnet and detects a position of the magnet that moves in association with the gear lever; and
a controller which determines a state of the gear lever on the basis of the position of the magnet detected by the sensor.

10. The vehicle of claim 9,
wherein the shift lever is configured to be substantially orthogonal to the gear lever,
and wherein the guide lever is configured to be substantially orthogonal to the shift lever.

11. The vehicle of claim 10,
wherein the shift lever extends in the select direction from a rotation center of the gear lever,
and wherein the guide lever extends in the shift direction from an extended end of the shift lever.

12. The vehicle of claim 9, further comprising an electronic control unit (ECU) which drives Idle Stop & Go (ISG) function on the basis of the measured magnet field at a neutral level where the power of the engine is not transmitted to wheels.

13. The vehicle of claim 9,
wherein the sensor is disposed to detect the position of the magnet when the gear lever is at a neutral position,
and wherein, on the basis of a signal sensed by the sensor, the controller determines whether the gear lever is at the neutral position or not.
